(19) United States
(12) Patent Application Publication
(10) Pub. No.: US 2016/0187303 A1
(43) Pub. Date: Jun. 30, 2016

(54) METHOD AND ROAD MANAGEMENT PLATFORM FOR MANAGING ROAD MAINTENANCE

(71) Applicant: FIH (HONG KONG) LIMITED, Kowloon (HK)

(72) Inventor: CHIA-LIANG CHANG, New Taipei (TW)

(21) Appl. No.: 14/735,818

(22) Filed: Jun. 10, 2015

(30) Foreign Application Priority Data
Dec. 30, 2014 (TW) 103146317

(51) Int. Cl. G01N 29/44; G01S 19/13; G01N 29/04

(52) U.S. Cl. CPC G01N 29/4427; G01N 29/04; G01S 19/13; G01N 2291/023; G01N 2291/0289

(57) ABSTRACT

A road condition acquiring method using a mobile device includes acquiring a road condition and a current geographic position information regarding the road condition, when a vibration sensor built-in the vehicle senses a vibration value, when the vibration value is larger than a predetermined value, the road condition and the current geographic position information is sent to a road management platform. And road maintenance management method and platform are also provided.

### CROSS-REFERENCE TO RELATED APPLICATIONS

This application claims priority to Taiwanese Patent Application No. 103146317 filed on Dec. 30, 2014, the contents of which are incorporated by reference herein.

### FIELD

The subject matter herein generally relates to road maintenance management technology, and particularly to a road maintenance management method and platform.

### BACKGROUND

A bad road condition can affect safety, and cause traffic accidents. Information gathered using sensors of the road condition is large and not easily calculated.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a road management platform.

FIG. 2 is a block diagram of one embodiment of a mobile device.

FIG. 3 illustrates a flowchart of one embodiment of a method for acquiring a road condition.

FIG. 4 illustrates a flowchart of one embodiment of a method for managing the road maintenance.

FIG. 5 illustrates a flowchart of one embodiment of a method for determining a road maintenance schedule.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

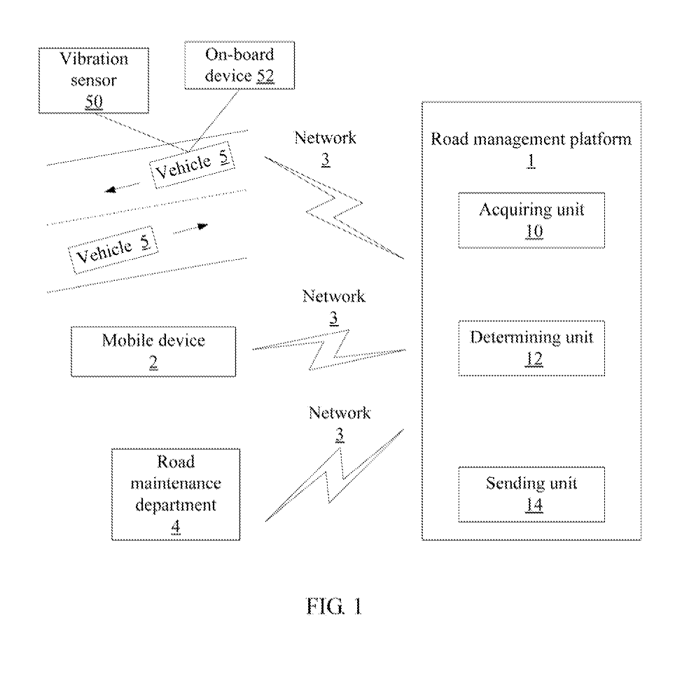

FIG. 1 illustrates a block diagram of one embodiment of a road management platform. In at least one embodiment, as shown in FIG. 1, the road management platform 1 includes, but is not limited to, an acquiring unit 10, a determining unit 12, and a sending unit 14. The road management platform 1 can be a server which can provide a plurality of road condition services. In at least one embodiment, the road management platform 1 can provide road condition information to an on-board device 52 attached to a vehicle 5, or to a mobile device 2 of a user in the vehicle 5, through optical instruments, radio equipment and radio frequency set on a road. FIG. 1 illustrates only one example that can include more or fewer components than illustrated, or have a different configuration of the various components in other embodiments.

In at least one embodiment, the road management platform 1 can communicate with a road maintenance department 4 and the mobile device 2 using a network 3. The network 3 can be a public telephone network, a mobile communication network, a Wi-Fi network, or any suitable wireless communication network. In some embodiments, the network 3 can be a wired network.

In at least one embodiment, there can be, but is not limited to, a vibration sensor 50, and an on-board device 52 in the vehicle 5. In at least one embodiment, the vibration sensor 50 can monitor road conditions when the vehicle 5 is on the road. The on-board device 52 can display an electronic map providing an accurate state of a road condition.

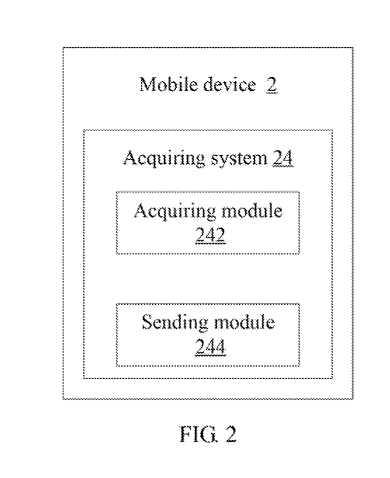

FIG. 2 is a block diagram of one embodiment of a mobile device. In at least one embodiment, the mobile device 2 can include an information acquiring system 24. The mobile device 2 can be a tablet computer, a smart phone, or any other device. In some embodiments, the mobile device 2 can be that of the user or passenger of the vehicle 5. The mobile device 2 further includes, but is not limited to, at least one processor and a storage device (not shown).

In at least one embodiment, the at least one processor can be a central processing unit (CPU), a microprocessor, or other data processor chip that performs functions of the information acquiring system 24 in the mobile device 1.

In at least one embodiment, the storage device can include various types of non-transitory computer-readable storage medium. For example, the storage device can be an internal storage system, such as a flash memory, a random access memory (RAM) for temporary storage of information, and/or a read-only memory (ROM) for permanent storage of information. The storage device can also be an external storage system, such as a hard disk, a storage card, or a data storage medium.

In at least one embodiment, the information acquiring system 24 can include an acquiring module 242, and a sending module 244. The function modules 242 and 244 can include computerized codes in the form of one or more programs, which are stored in a storage device of the mobile device 2. At least one processor of the mobile device 2 executes the computerized codes to provide functions of the function modules.

The acquiring module 242 can acquire a road condition and a current geographic position information regarding the road.

In at least one embodiment, when the vehicle 5 is on a bad road, for example, the road condition comprises pot holes, gravel and cracks, the vibration sensor 50 can monitor and display a vibration value. The acquiring module 242 can acquire the vibration value and determine whether the vibration value is larger than a predetermined value (e.g. four centimeters).

In at least one embodiment, the current geographic position information regarding the road can be acquired by a position device of the mobile device 2, the current geographic position information can comprise latitude and longitude. The position device of the mobile device 2 can be a Global Position System(GPS)

The sending module 244 can send the road condition and the current geographic position information to a road management platform 1, when the vibration value is determined larger than a predetermined value. For avoiding a vibration caused by the vehicle 5, after determining the vibration value is larger than the predetermined value, the road condition and the current geographic position information is sent to a road management platform 1.

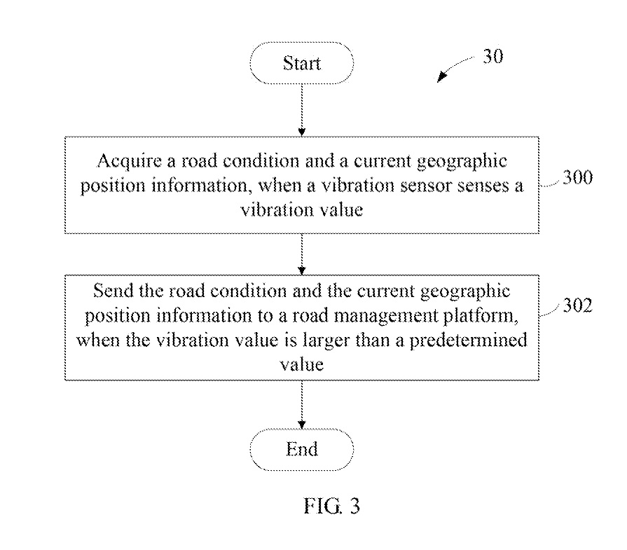

Referring to FIG. 3, a flowchart is presented in accordance with an example embodiment. An example method 30 is provided by way of example, as there are a variety of ways to carry out the method. The example method 30 described below can be carried out using the configurations illustrated FIG. 2, for example, and various elements of these figures are referenced in explaining example method 30. Each block shown in FIG. 3 represents one or more processes, methods, or subroutines, carried out in the example method 30. Furthermore, the illustrated order of blocks is by example only and the order of the blocks can be changed. The example method 30 can begin at block 300. Depending on the embodiment, additional blocks can be added, others removed, and the ordering of the blocks can be changed.

At block 300, an acquiring module acquires a road condition and a current geographic position information regarding the road, when the vehicle 5 is on the road and the vibration sensor 50 senses a vibration value.

At block 302, a sending module sends the road condition and the current geographic position information to a road management platform 1 when a determination is made that the sensed vibration value is larger than a predetermined value.

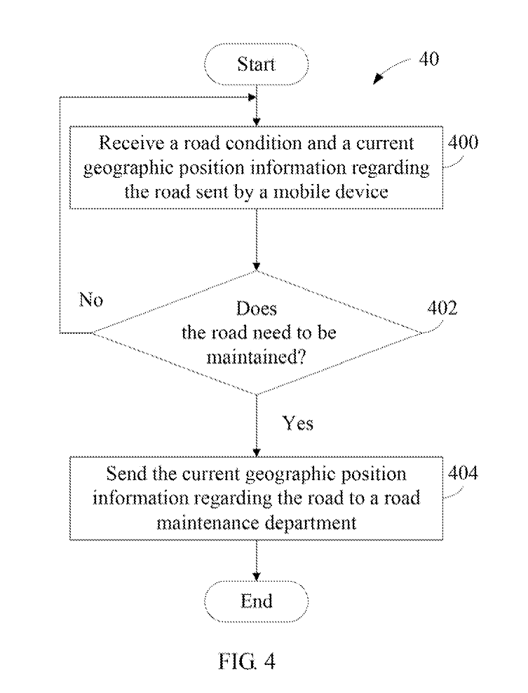

Referring to FIG. 4, a flowchart is presented in accordance with an example embodiment. An example method 40 is provided by way of example, as there are a variety of ways to carry out the method. The example method 40 described below can be carried out using the configurations illustrated FIG. 1, for example, and various elements of these figures are referenced in explaining example method 40. Each block shown in FIG. 4 represents one or more processes, methods, or subroutines, carried out in the example method 40. Furthermore, the illustrated order of blocks is by example only and the order of the blocks can be changed. The example method 40 can begin at block 400. Depending on the embodiment, additional blocks can be added, others removed, and the ordering of the blocks can be changed.

At block 400, a receiving unit receives a road condition and a current geographic position information regarding the road sent by the mobile device 1.

At block 402, a determining unit determines whether the road needs to be maintained. When a determination is made that the road does not need to be maintained, the processor returns to block 400. When a determination is made that the road needs to be maintained, the processor goes to block 404.

At block 404, a sending unit sends the current geographic position information regarding the road to the road maintenance department 4.

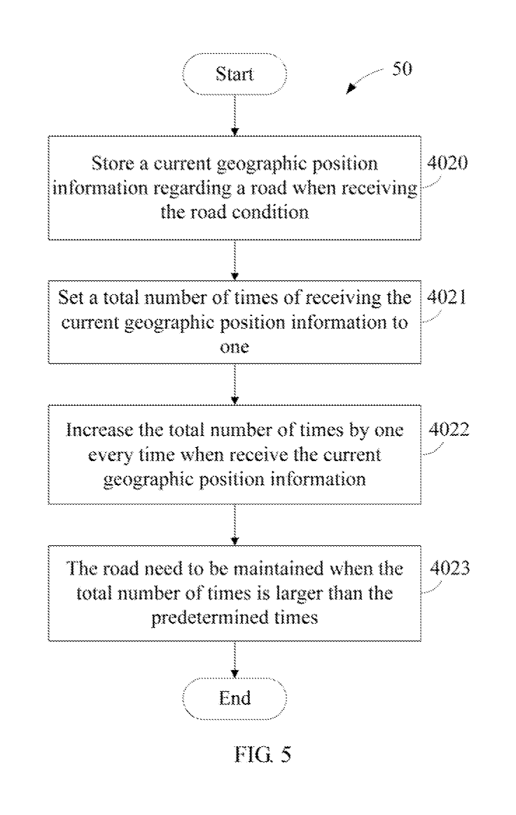

In some embodiments, whether the road needs to be maintained is determined by the following method 50. Referring to FIG. 5, a flowchart is presented in accordance with an example embodiment. An example method 50 is provided by way of example, as there are a variety of ways to carry out the method. The example method 50 described below can be carried out using the configurations illustrated FIG. 1, for example, and various elements of these figures are referenced in explaining example method 50. Each block shown in FIG. 5 represents one or more processes, methods, or subroutines, carried out in the example method 50. Furthermore, the illustrated order of blocks is by example only and the order of the blocks can be changed. The example method 50 can begin at block 4020. Depending on the embodiment, additional blocks can be added, others removed, and the ordering of the blocks can be changed.

At block 4020, a determining unit stores the current geographic position information regarding the road when receiving the road condition.

At block 4021, the determining unit sets a total number of times of receiving the current geographic position information to one.

At block 4022, the determining unit increases the total number of times by one every time when receiving the current geographic position information.

At block 4023, the determining unit determines whether the total number of times is larger than a predetermined times (e.g., twenty times). If the total number of times is larger than the predetermined times, a determination is made that the road needs to be maintained.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for acquiring a road condition executable on a mobile device located in a vehicle, the mobile device comprising at least one processor, the method comprising:
acquiring a road condition and current geographic position information regarding the road, when a vibration sensor attached to the vehicle senses a vibration value;
determining, using the at least one processor, that the vibration value is larger than a predetermined value; and
upon such determination, sending the road condition and the current geographic position information to a road management platform.

2. The method according to claim 1, wherein the road condition is monitored by a vibration sensor, and the current geographic position information comprise latitude and longitude accessed by a on-board device of the vehicle.

3. A method for managing road condition executable on a road management platform, the method comprising:
receiving a road condition and a current geographic position information sent by a mobile device;
determining, using at least one processor, whether the road need to be maintained; and
sending the current geographic position information to a road maintenance department, when the road need to be maintained.

4. The method according to claim 3, wherein whether the road need to be maintained is determined by:
increasing one to a total number of times of receiving the current geographic position information;
determining, using the at least one processor, whether the total number of times is larger than a predetermined times; and
sending the current geographic position information to a road maintenance department when the total number of times is larger than a predetermined times.

5. The method according to claim 3, further comprising:
sending the road condition and the current geographic position information to mobile devices located in vehicles approaching the current geographic position.

6. A road management platform having at least one processor to perform a method for managing road maintenance, wherein the method comprises:
receive a road condition and a current geographic position information sent by a mobile device;
determine, using at least one processor, whether the road need to be maintained; and
send the current geographic position information to a road maintenance department, when the road need to be maintained.

7. The road management platform according to claim 6, wherein whether the road need to be maintained is determined by:
increase one to a total number of times of receiving the current geographic position information;
determine, using the at least one processor, whether the total number of times is larger than a predetermined times; and
send the current geographic position information to a road maintenance department when the total number of times is larger than a predetermined times.

8. The road management platform according to claim 6, further comprising:
send the road condition and the current geographic position information to a mobile devices located in vehicles approaching the current geographic position.
